(19) United States
(12) Patent Application Publication
(10) Pub. No.: US 2003/0184521 A1
(43) Pub. Date: Oct. 2, 2003

(54) Mouse with storage section for cord and the like

(76) Inventor: Go Sugita, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/240,171

(22) PCT Filed: Mar. 28, 2001
(86) PCT No.: PCT/JP01/02535

(30) Foreign Application Priority Data
Mar. 31, 2000 (JP) 2000-0098543
Mar. 31, 2000 (JP) 2000-0001937
Oct. 25, 2000 (JP) 2000-0325227

(51) Int. Cl. G09G 5/08

(52) U.S. Cl. 345/163

(57) ABSTRACT

A mouse which allows free adjustment of the cord length, which is superior in portability, which is not interfered with by the cord during operation, and which looks neat and tidy. A storage section (3) having a space capable of storing a joint (7) or a connector (8) at the front end of a cord (6) is disposed in the mouse main body, and an openable/closable opening/closing lid (9) is attached to the storing section (3), and the storing section (3) is disposed in the lateral side of the mouse main body, with the lateral plate of the mouse main body (1) forming the openable/closable opening/closing lid (9) or, alternatively, the storing section (3) is disposed in the lateral side of the mouse main body, with the lateral plate or bottom plate of the mouse main body forming the openable/closable opening/closing lid (9).

### TECHNICAL FIELD

The present invention relates to a mouse with storage space defined therein for cord and its terminal members. The present invention relates also to such mouse provided within its main body with a light emitting element adapted to be energized as a click button is depressed so that a part of the mouse may be illuminated.

### BACKGROUND ART

The mouse, one of the input devices for the computer system, usually comprises the ball partially exposed downward from the bottom wall and the click buttons provided on the top wall. The amount as well as the direction by and in which the mouse has moved on the flat surface are determined by rolling of the ball is operatively associated with the movement of the cursor displayed on the display screen to facilitate various operations such as selection of menu and correction of table and/or sentence. The mouse enables the cursor displayed on the screen to be rapidly moved to a desired location with a relatively high accuracy merely by moving the mouse with user's hand and, in addition, the mouse can be obtained at a relatively low expense. Thus the mouse has been widely used as the auxiliary input device for the computer system.

Connection between the computer system and the mouse is established by electrically coupling the connector provided on the distal end of the cord extending from the mouse to the predetermined connector provided on the computer's main body. While the length of the cord extending from the mouse is not specified, the cord has its length in order of 60-1500 mm on account of the fact that the main body of the computer system is usually placed below or at the side of the desk and therefore the length sufficient to ensure the desired operationality of the mouse.

Recently, so-called lap-top type system which is convenient in its portability has come in wide use and there is a trend to downsize and thin such lap-top type system more and more. Correspondingly, it is also required to improve the portability of the mouse used with the lap-top type system. The conventional mouse has been inconvenient so far as its portability is concerned because the relatively long cord must be wound around the mouse's main body or bundled using rubber band before carried about, in order to prevent the cord from tailing down or spreading. To overcome this problem, there have already been various proposals, for example, of the mouse adapted to store the cord therein and the cordless mouse.

The measures to solve the problems as have been described above have been proposed, for example, by Japanese Laid-Open Patent Application Gazettes Nos. 1996-303836; 1997-81315 and Japanese Laid-Open Utility Model Application Gazettes Nos. 1991-9036; 1991-1480. Japanese Laid-Open Patent Application Gazette No. 303836 discloses a mouse provided with a cord storage reel having a rotary shaft and a stopper member adapted to stop further rotation of this cord storage reel so that the stopper member may be operated to take the cord out and in.

Japanese Laid-Open Patent Application Gazette No. 1997-81315 describes a mouse having a switch to control rotation of a cord storage reel so that taking in and out of the cord may be selectively achieved by operating this switch. Japanese Laid-Open Utility Model Application Gazette No. 1991-9036 discloses a mouse provided therein with a cord storage reel. Japanese Laid-Open Utility Model Application Gazette No. 1991-1480 describes a mouse provided therein with a cord winding shaft having a ratchet wheel fixed thereon so that the cord winding shaft may normally be rotated only in one direction but may be rotated in the opposite direction by releasing a detent of this ratchet wheel. Thereupon only the cord is retracted into a main body of the mouse.

The Japanese Laid-Open Patent Application Gazette No. 2000-322195 of the applicant proposed the mouse distinguished from those disclosed in the above-identified Gazettes.

The cord extending from the mouse is provided at its distal end with the terminal section and the connector by means of which the cord is electrically connected to the computer system. These terminal section and connector generally have widths larger than that of the cord, so it has been impossible to store them within the main body of the mouse. Particularly in the case of the mouse adapted to store the cord therein in the manner as has been described above, the distal end of the cord defined by the terminal section and the connector remain exposed outside the main body of the mouse after the cord has been retracted into the main body. The distal end of the cord remaining exposed outside the main body has caused the user to experience inconvenience when it is desired to carry about the mouse.

For the cordless mouse, it is required to ensure a space therein sufficient to contain a receiving set and its power source, so the entire size of the mouse inevitably becomes bulky. Furthermore, in view of the fact that operation of the mouse is sometimes obstructed by extraneous signals, it is difficult to ensure a high stability so far as its operation is concerned.

Referring again to the mouse having the cord storage compartment therein, while it is certainly convenient that the length of the cord is adjustable during use of the mouse, the terminal section and the connector remaining exposed outside the main body of the mouse deteriorates the portability of the mouse.

Recently, so-called lap-top type system which is convenient in its portability has come in wide use and there is a trend to downsize and thin such lap-top type system more and more. Correspondingly, it is also required to downsize the mouse used to operate the cursor. More specifically, efforts have been made to configure and dimension the mouse so as to be conveniently held by user's hand without deterioration of its manipulating efficiency. Consequently, many of the conventional mice have been of tongue-shape with the pair of click buttons dimensioned as small as possible.

Conventionally, less importance has been given to either appearance or decorative effect of the mouse. As a result, there has often been a problem in the decorative effect of the mouse even when this mouse is satisfactory in its function. Particularly because there is a tendency that age of the users becomes younger and younger, the conventional mouse has become less popular.

An object of this invention is to provide a mouse provided therein with a cord storage compartment into which the cord can be retracted together with its distal end defined by a terminal section and a connector.

Another object of this invention is to provide a mouse having a high decorative effect positively supported by young users.

Still another object of this invention is to provide a mouse in which its upper lid entirely or right and left buttons thereon is or are adapted to emit light during use of the mouse and such light emission may visually indicate that the mouse is normally operating and, at the same time, contribute to improvement of a decorative effect.

Further another object of this invention is to provide a mouse provided on outer surface of its main casing with stripes having metallic luster contributing to the improved decorative effect.

### DISCLOSURE OF THE INVENTION

The objects set forth above are achieved, according to this invention, by improved mouse provided with the cord storage compartment as will be described below.

The first one of the objects is achieved by a mouse provided therein with a cord storage compartment into which the cord can be retracted and stored, the mouse adapted to be electrically connected to an input board of a computer system comprising an upper lid having thereon right and left manual operation buttons, a bottom frame and the storage compartment within which the cord extending between the mouse and the input board is directly stored in folded up state or taken up around a reel mechanism, the mouse being characterized by that a main body of the mouse contains therein a detector mechanism adapted to detect an amount by which the main body of the mouse is moved, a wiring board having an electronic control circuit thereon and the storage having a space sufficient large to store the cord inclusive of a terminal section as well as a connector on a distal end of the cord, wherein the storage compartment is provided on its opening side with an open- and closable lid.

The same object is achieved also by the embodiment in which the storage compartment is provided on a lateral side of the main body of the mouse and the open- and closable lid is formed by a side wall or a bottom wall of the main body of the mouse and the embodiment in which the cord to be stored together with the terminal section and the connector into the storage compartment is automatically or manually taken up around the reel mechanism and thereby stored within the storage compartment and wherein, after the terminal section and connector on the distal end of the cord have been taken out from said storage compartment and the open- and closable lid has been closed, a desired length of the cord can be adjustably reeled out from the storage compartment.

This object is achieved also by the embodiment in which the open- and closable lid for the cord storage compartment is hinge-connected to a part of the mouse's main body and has a lock mechanism adapted to lock the open- and closable lid at its closed position and the embodiment in which the open- and closable lid is formed with a slot through which the cord stored in the storage compartment can be pulled out and the lock mechanism can be operated by a lid operating member provided on the outer surface of the mouse's main body.

The same object is achieved also by the embodiment in which the terminal section and connector are biased to bounce out from the storage compartment as the open- and closable lid is opened or the embodiment in which the cord is manually or automatically retracted into the cord storage compartment under a restoring force of the biasing member.

The second object of this invention is achieved by a mouse defined by a bottom frame and an upper lid provided with right and left operating buttons and containing therein a wiring board supporting an electronic control circuit and a detector mechanism adapted to detect an amount by which the mouse is moved, said mouse being characterized by that the mouse further includes light emitting elements adapted to be turned on as the mouse is moved and/or click buttons are depressed and thereby to illuminate the upper lid entirely or partially or to illuminate only the click buttons with appropriate luminosity.

The same object is achieved by a mouse defined by a bottom frame and an upper lid provided with right and left operating buttons and containing therein a wiring board supporting an electronic control circuit and a detector mechanism adapted to detect an amount by which the mouse is moved, the mouse being characterized by that portions of the upper lid defining the click buttons are formed by suitable light-transmitting members and light emitting elements underlie these click buttons, the light emitting elements being adapted to be turned on as the mouse is moved and/or click buttons are depressed and thereby to illuminate the click buttons so that how the mouse is functioning can be visually recognized by the user.

The third object of this invention is achieved by the embodiment in which the light transmitting members forming the click buttons include diffusing plates adapted to diffuse the incident light coming from the underlying light emitting elements or a mouse defined by a bottom frame and an upper lid provided with right and left operating buttons and containing therein a wiring board supporting an electronic control circuit and a detector mechanism adapted to detect an amount by which the mouse is moved, the mouse being characterized by that a part of the upper lid or a boundary between the upper lid and the bottom frame is provided with rectilinear or streamlined stripes having metallic luster.

The mouse according to the invention allows the cord inclusive of the terminal section as well as the connector on the distal end of the cord to be stored into the storage compartment provided within the main body of the mouse. This feature is convenient for carrying about the mouse. The cord storage compartment storing the cord together with the terminal section and the connector can be easily opened and closed by one-touch operation.

The appearance of the mouse is not deteriorated due to the presence of the pass-through slot formed in the main body because the size of this pass-through slot is as small as the diameter of the cord is.

According to the invention, the open- and closable lid for the cord storage compartment is provided on the lateral side of the mouse's main body and therefore the lock mechanism (engagement mechanism) for this lid can be easily operated with the user's thumb when it is desired to close or to open the lid. Depending on the individual user's better arm, the cord storage compartment may be provided right or left side of the mouse so that the open- and closable lid may be easily opened and closed with the thumb of this better arm.

The open- and closable lid for the cord storage compartment is hinge-connected to a part of the mouse's main body so that this lid may make a part of the mouse's side wall. Such arrangement advantageously reduces the number of parts and correspondingly reduces the manufacturing cost. The lock mechanism for the open- and closable lid may be provided in the form of snap-fit projection and depression on the peripheral edges of the lid and the opening of the mouse's main body, respectively, to improve a handling efficiency of this lock mechanism. It is also possible without departing from the scope of the invention to arrange the cord storage compartment so that the terminal section and the connector defining the distal end of the cord are bounced out automatically as the lid is opened. To this end, for example, an elastic member serving as a seat may be provided within the storage compartment and the terminal section as well as the connector may be always placed under a pressure exerted by the lid so long as the terminal section and the connector are stored together with the cord within the storage compartment. The elastic member may be rubber or sponge plate or a spring.

The reel assembly provided within the main body facilitates the cord to be automatically or manually retracted into the mouse together with the terminal section and the connector.

The biasing member operatively associated with the reel assembly is activated as the terminal section and the connector is taken out from the storage compartment together with the cord, and consequently the restoring force is accumulated. However, this restoring force is unable to retract the cord so long as the stopper is in engagement with the reel assembly. The reel assembly is driven in the backward direction under the restoring force of the biasing member first when the stopper is released by externally operating this. In this manner, the cord inclusive of the terminal section and the connector is automatically retracted into the mouse. Then, the open- and closable lid may be closed to present the appearance defined by the mouse's main body alone.

The force accumulated in the biasing member as the cord is pulled out from the mouse is prevented by the stopper from rotating the spool of the reel assembly in the backward direction and thereby the cord is prevented from being retracted into the mouse even if the cord is slackened. The reel assembly becomes free to rotate in the backward direction under the restoring force of the biasing member first when the stopper is released. In this manner, the cord inclusive of the terminal section and the connector is automatically retracted into the mouse. Then, the open- and closable lid may be closed to store the cord inclusive of the terminal section and the connector within the mouse's main body.

According to the invention, the entire upper lid of the mouse's main body or the portions thereof defining the click buttons are formed by suitable light-transmitting members and light emitting elements underlying these click buttons are adapted to be turned on as said mouse is moved and/or click buttons are depressed and thereby illuminate the click buttons with appropriate luminosity so that the user may visually recognize how the mouse is functioning while amusing him- or herself. In the case of the click buttons formed using suitable light transmitting material, the portions defining the click buttons are illuminated with appropriate luminosity as the light emitting elements are turned on light. The light transmitting material containing coloring agent may be used to emit the corresponding colored light. Alternatively it is possible to use a colored light source.

According to the invention, the mouse may be entirely made of suitable synthetic resin. Alternatively, the mouse may be entirely made of the light transmitting material. In this case, the diffusion plate may be layered on the inner surface of the light transmitting material to illuminate the entire surface of the mouse's main body by the light emitted from the light emitting elements underlying the diffusion plate with appropriate luminosity. It is also possible to illuminate only the upper lid.

Resistance of the cord to repeated stretching and contraction as well as to repeated twisting may be improved by reinforcing the cord with suitable reinforcing material. Strength of the cord decreases proportionately as the diameter of the cord is reduced. In consequence, it is apprehended that breaking of wire might occur. Even if the cord is relatively fine, the desired strength can be ensured by using such reinforcing material.

The force accumulated in the biasing member as the cord is pulled out from the mouse is prevented by the stopper from rotating the spool of the reel assembly in the backward direction and thereby the cord is prevented from being retracted into the mouse even if the cord is slackened. The reel assembly becomes free to rotate in the backward direction under the restoring force of the biasing member first when the stopper is released. In this manner, the cord inclusive of the terminal section and the connector is automatically retracted into the mouse. Then, the open- and closable lid may be closed to store the cord inclusive of the terminal section and the connector within the mouse's main body.

### BRIEF DESCRIPTION OF THE DRAWINGS

FIG. 1 is a side view showing a first embodiment of the mouse having therein the storage compartment for cord and the associated elements according to the invention as its open- and closable lid has been opened;

FIG. 2 is a plan view showing the first embodiment with its top wall removed to illustrate its internal arrangement;

FIG. 3 is a front view of the first embodiment;

FIG. 4 is a perspective view showing the first embodiment as its open- and closable lid has been opened;

FIG. 5 is a fragmentary side view of the first embodiment as partially broken away, showing a reel assembly;

FIG. 6 is an exploded perspective view of the reel assembly;

FIG. 7 is a perspective view showing a second embodiment of the invention;

FIG. 8 is a perspective view showing a third embodiment of the invention;

FIG. 9 is plan view showing a fourth embodiment of the invention with its top wall removed to illustrate its internal arrangement;

FIG. 10 is a bottom plan view showing the fourth embodiment with its bottom plate;

FIG. 11 is a front view showing a fifth embodiment of the invention;

FIG. 12 is a perspective view showing a sixth embodiment of the invention;

FIG. 13 is a plan view showing an inner side of the top wall in the sixth embodiment;

FIG. 14 is a longitudinal sectional view of the top wall in the sixth embodiment;

FIG. 15 is a schematic plan view of the sixth embodiment showing an inner arrangement of its bottom plate;

FIG. 16 is a side view showing a seventh embodiment;

FIG. 17 is a plan view showing an inner side of its top wall in the seventh embodiment; and

FIG. 18 is a plan view of the seventh embodiment showing an inner arrangement of its bottom plate.

### DESCRIPTION OF THE PREFERRED EMBODIMENTS

Details of the mouse having therein the storage compartment for cord or the like according to the invention will be more fully understood from the description of the preferred embodiments given hereunder in reference with the accompanying drawings.

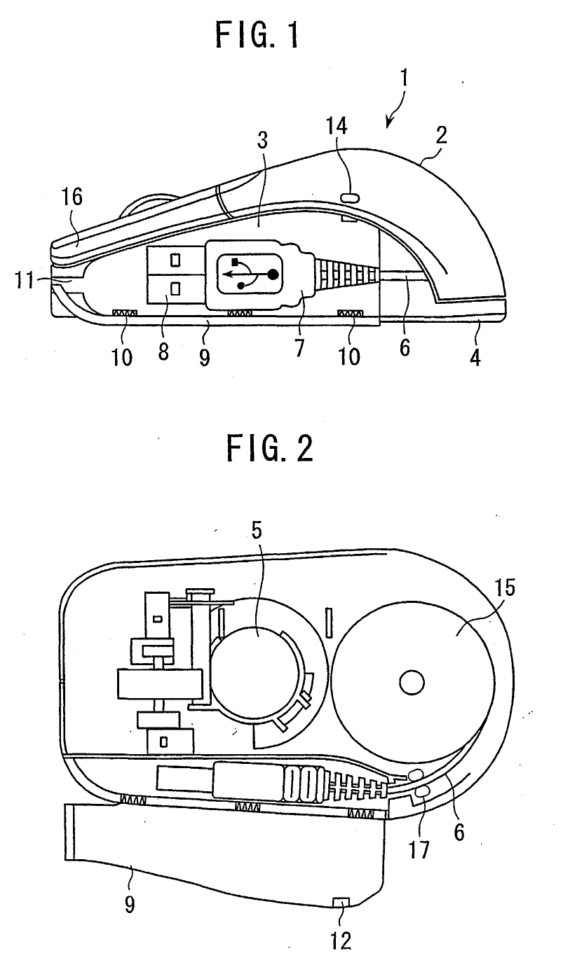

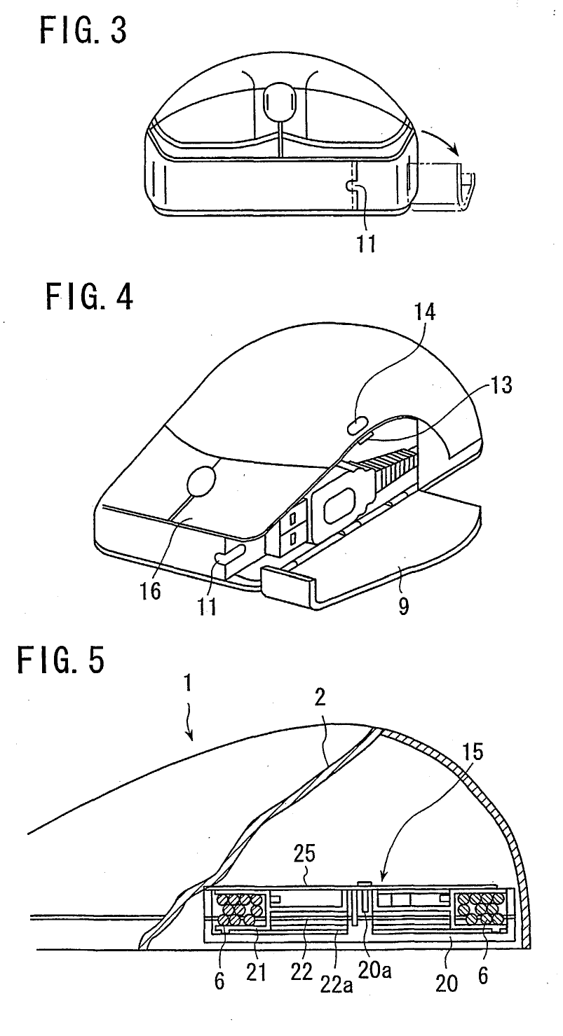

The mouse 1 having therein the storage compartment for cord or the like shown by FIGS. 1 and 2 generally comprises a main body casing 2, the storage 3 for cord and the associated elements, bottom plate 4 and a ball 5. The components other than the storage compartment 3 are practically similar to those in the conventional mouse (referred to hereinafter simply as “mouse”) and detailed description of these components will be eliminated here.

The main body casing 2 is shaped to have a curved surface so that the main body casing 2 can be reliably held in a user's palm and easily manipulated. The storage compartment 3 is defined by a lateral space within the main body casing 2, sufficient to store a terminal section 7 and its connector 8 provided on a distal end of cable 6. While material for the main body casing 2 is not specified, the main body casing 2 is generally formed of synthetic resin such as ABS resin. The storage compartment 3 is provided with a lid 9 adapted to be open- and closable around pivot members 10.

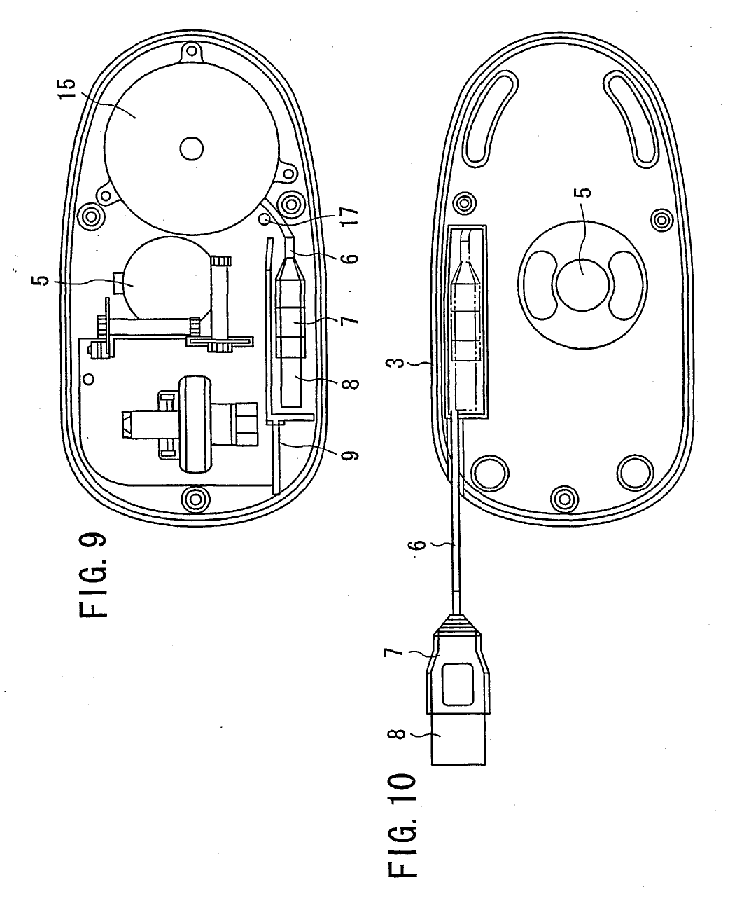

The arrangement of the bottom plate 4 as and the location of the storage compartment 3 are not limited to those as illustrated. Specifically, it is possible to provide the storage compartment 3 on the lateral side opposed to that illustrated or in an upper space within the main body casing 2. Obviously, a location at which the cord 6 connected to the terminal section 7 and therefore to its 8 is to be stored will be changed as the storage compartment 3 is relocated. The location of the open- and closable lid 9 also is not limited the location on the lateral side of the main body casing 2 but it is also possible to use a part of the bottom plate 4 so that this part may be detached from the remaining part of the bottom plate 4 to open the main body casing 2 and attached again to the remaining part to close the main body casing 2, as will be understood from FIG. 9. There is provided a ball 5 in the vicinity of the bottom plate 4. The ball 5 is partially exposed downward from the bottom plate 4 and adapted to roll as the mouse 1 is moved on flat surface. A distance by which the ball 5 has been moved is detected and processed by an electronic circuit provided on the bottom plate 4. On the left side wall of the main body casing 2, a plurality of guide rollers allowing the cord 6 to be smoothly guided when the cord 6 is extended from and/or retracted into the mouse 1. The storage compartment 3 is provided with the open- and closable lid 9 which may be either hinge-supported type or simple interlocking type. Wall of this open- and closable lid 9 or the mouse 1 is formed with a pass-through slot 11 so that the cord 6 may be extended from or retracted into the mouse 1 through this pass-through slot 11 after the terminal section 7 has been taken out together with the connector 8. As illustrated, this pass-through slot 11 is provided on a front side of the mouse 1, i.e., the side thereof facing away from the user. The lid 9 is provided with a projection 12 adapted to be engaged with a pawl 13 provided on the main body casing 2 in the vicinity of an opening corresponding to the lid 9 with a pawl 13. This pawl 13 may be moved downward by a manual operation button 14 to disengage the projection 12 of the lid 9 from the pawl 13. Reference numeral 16 designates click-buttons arranged side by side so as to define the front region of the mouse 1. Reference numeral 17 designates guide rollers for the cord 6.

The mechanism for storage of the cord 6 within the main body casing 2 may be operated manually or automatically. The open- and closable lid defining the lateral side wall of the main body casing improves maneuverability of the locking mechanism (engaging mechanism) for the open- and closable lid so that the lid may be easily closed and/or opened with the user's thumb. Depending on the user's better arm, the storage compartment may be provided on right or left side of the mouse to ensure that the operation of opening and/or, closing the lid is further facilitated with the user's thumb.

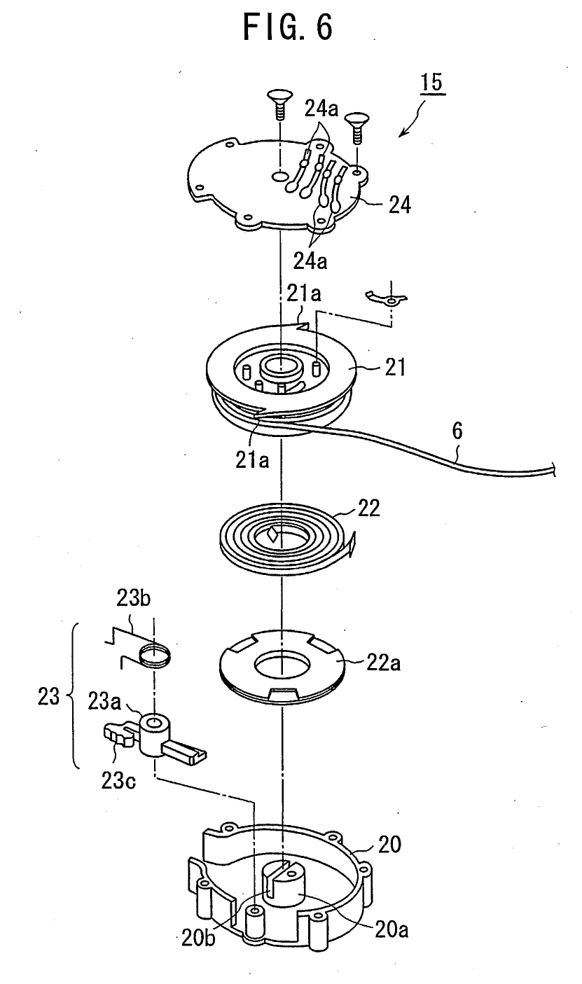

The reel assembly 15 may adopt a take-up stopper mechanism as shown by FIGS. 5 and 6. The reel assembly 15 principally comprises a casing 20, a spool 21, a spiral spring 22 and a cover 25. The casing 20 has the minimum space to contain therein the spool 21, the spiral spring 22, a stopper mechanism 23 and the others. A central shaft 20a mounted on the casing 20 is engaged with a central opening of the spool 21 so that the spool 21 may be rotated around this central shaft 20a. The central shaft 20a is formed on its top surface with a groove 20b adapted to receive and fix one end of the spiral spring 22. The cover 25 of the casing 20 is provided on its inner wall surface with the stopper mechanism 23 adapted to restrict rotation of the spool 21. While material for the casing 20 is not specified, it is preferred to use suitable synthetic resin, for example, ABS resin from the viewpoint of the manufacturing process and cost.

The spool 21 has a configuration like a bobbin which is substantially H-shaped in its axial section so that the cord 6 may be wound and stored on depressed portion of the spool 21. The spool 21 is formed in its center formed with a cylindrical opening into which the central shaft 20a of the casing 20 is inserted. A plurality of conductive strips 24 are fixed to the cover 25 and have terminals 24a, respectively. Four lead wires branched from the end of cord 6 and extending through the spool 21 from below are connected to the upper surface of this spool 21, respectively, so as to come in contact with the terminals 24a.

Additionally, a detent 23a having a lock element 23c may be engaged with stoppers 21a formed on the peripheral edge of the spool's upper flange. Each of the stoppers 21a is configured so that it is not engaged with a detent 23a of the stopper mechanism when the cord 6 is pulled out from the mouse 1 and thereby the spool 21 is rotated. The stoppers 21a come in engagement with the detent 23a first when the user intends to rotate the spool 21 in the backward direction.

The cord 6 serves to transmit information on amount and direction of the mouse movement to the computer system. The connector 8 for connecting with the computer system is attached to the end of cord 6 with a terminal section interposed therebetween. The length of the cord 6 is preferably about 60 mm-1,500 mm in consideration of distance from the computer system to the place for input operation. But, the balance between the thickness and length of the cord should be considered, because the longer the cord is, the larger the space the cord occupies when wound up. In the conventional mouse, the cord is about 3-5 mm in diameter. It is difficult for the cord of such diameter to ensure enough length and to be stored entirely in the casing 20. Accordingly, the cord is preferably thinner, for example, 1.5 mm-2.5 mm in diameter. But the strength of the cord should be ensured, because a thinner cord reduces its strength.

The cord 6 is configured by bundling 4-6 lead wires together. The cord 6 is covered with a synthetic resin jacket. Each lead wire is formed by twisting a lot of copper thin conductive filaments together with reinforcing elements comprising a lot of aramid fibers which have high strength and scratch resistance. The manner of reinforcing the cord 6 is not limited thereto but the other appropriate manners can be adopted. For example, the manner can be used, in which mesh reinforcing elements formed of twisted copper wires are inserted among the lead wires covered with synthetic resin jacket of the cord 6. The spiral spring 22 is arranged between the casing 20 and the spool 21. The spiral spring 22 is made from SUS, and the one end of the spiral spring 22 is fixed to the casing 20, while the other end is fixed to the spool 21.

A circuit substrate is arranged on the upper surface of the spool 21. The circuit substrate transmits electrical signals to a main circuit substrate by contacting with terminals attached to the spool 21. A plurality of screw holes are formed in the periphery of the circuit substrate. A screw hole for attaching the spool 21 to the central shaft 20a is also formed in the center of the circuit substrate. A ring-shaped copper plate is mounted on the surface of the substrate facing the spool 21 in conformity with a concentric circle which the terminals describe as the spool 21 rotates. By this configuration, the connection with the main substrate is ensured even when the spool 21 is rotated.

Additionally, the stopper mechanism 23 is provided within the casing 20, and the detent 23a is attached to the casing 20 by means of a spring 23b. A latch of the detent 23a is pressed against the recessed wall of a bottom plate 22a, and the detent 23a is not engaged with none of recesses of the bottom plate 22a when the cord 6 is pulled out from the mouse 1 and thereby the spool 21 is rotated, but the latch of the detent 23a is engaged with one of the recesses of the bottom plate when the spool 21 is rotated in the backward direction under the biasing force of the spiral spring 22 so as to prevent the spool 21 from being rotated.

In the case of the mouse 1 having such reel assembly 15, the lid operating button 14 may be depressed to disengage the pawl 13 from the projection 12 and open the open- and closable lid 9, then the connector 8 and the terminal section 7 may be taken out , thereafter the open- and closable lid 9 may closed, and then the cord 6 may be passed through the pass-through slot 11. When the cord 6 is pulled out from the mouse 1, the spool 21 is rotated, and the spiral spring 22 is tightened so that the restoring force is accumulated therein. With the detent 23a is positioned to be engaged with any of the recesses of the bottom plate 22a, the spool 21 is prevented from being rotated and the cord 6 is retained without being retracted into casing 20, even if the code 6 is slackened. First when user operates the detent 23a, the detent 23a is disengaged from the recess, the spool 21 comes into free rotation, and is rotated by the force of the spiral spring 22 in the direction opposite to the direction in which the cord 6 is pulled out of the mouse 1, so that the cord 6 is wound up around the spool and automatically stored into casing 20.

After the cord 6 is wound up automatically, the lid operating button 14 is operated to open the open- and closable lid 9, then the connector 8 etc. is stored into the storage compartment 3, and thereafter the open- and closable lid 9 is closed. Alternatively, the cord 6 may be wound up by manually rotating the spool 21 of the reel assembly 15.

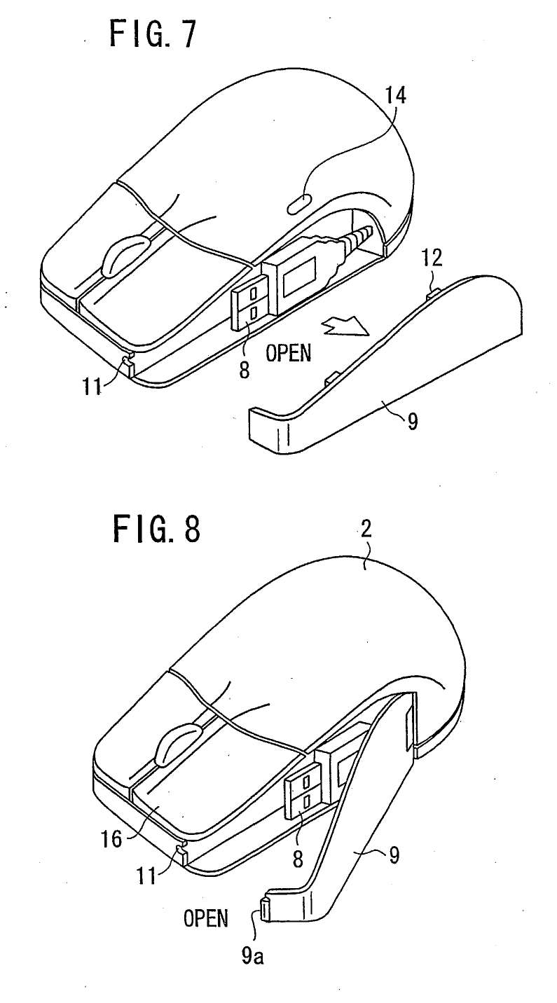

In the second embodiment of this invention shown in FIG. 7, the storage compartment 3 is closed in snap-fashion by the open- and closable lid 9. In this case, the lid operating button 14 may be eliminated, and a snap means 9a may be provided on the open- and closable lid 9 so that the open- and closable lid 9 can be easily detached from the mouse 2. The open- and closable lid 9 of this embodiment shown in this figure is provided on the left side of this mouse 1, however, the position of the open- and closable lid 9 is not limited thereto, but the open- and closable lid 9 may be provided on the bottom plate 4. Alternatively, the storage compartment 3 may be formed in the right side of the mouse 1 and the open- and closable lid 9 may be provided on the side surface of the mouse.

In the third embodiment of this invention~shown in FIG. 8, a hinge is provided on a proximate side end of the open- and closable lid 9 so that the open- and closable lid 9 can be opened and closed in the hinge-fashion.

In the fourth embodiment of this invention shown in FIGS. 9 and 10, the open- and closable lid 9 is provided on the bottom plate. This open- and closable lid 9 may be detached from the mouse 1, thereafter the connector 8 etc. may be taken out from the storage compartment 3, and the storage compartment 3 may be then closed by the open- and closable lid 9 so that the mouse can be used.

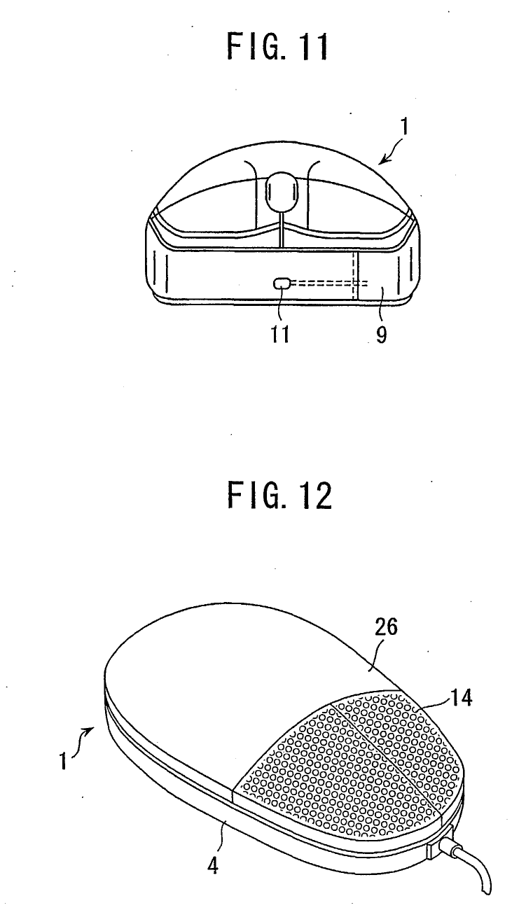

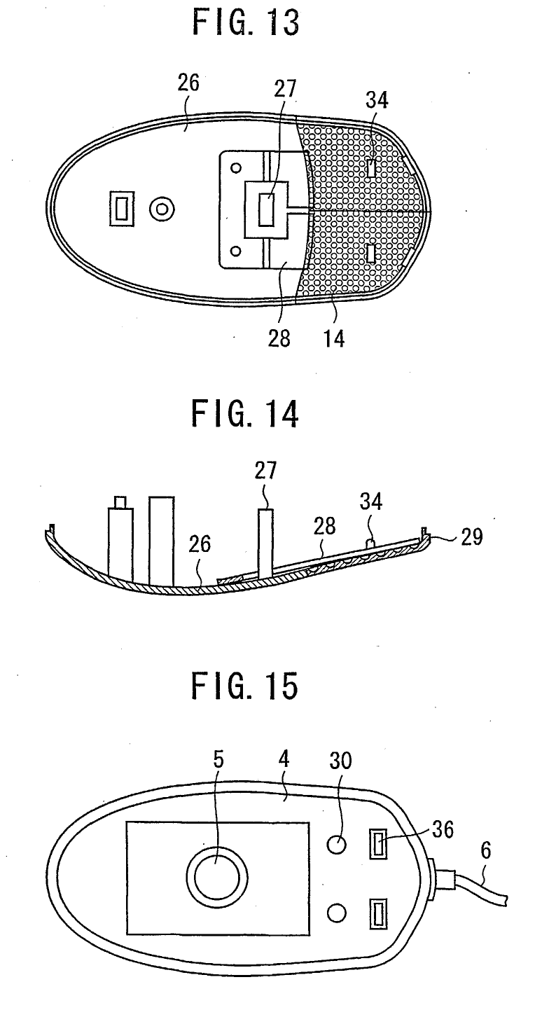

In the fifth embodiment of this invention shown in FIG. 11, the pass-through slot is provided in the front center of the mouse 1. In this case, a plurality of guide rollers may be arranged in the passage of the cord 6 so that the cord 6 can be smoothly pulled out from the mouse 1, or a synthetic resin plate having a sliding surface may be arranged so that the cord 6 can be guided when extended from and/or retracted into the mouse 1.

In the sixth embodiment of this invention shown in FIG. 12, the main body casing 2 of the mouse is configured so that an upper lid 26 and the bottom plate 4 are coupled each other. The upper surface of the upper lid 26 is curved such that it may fit with the hand holding the mouse and it is easy to handle the mouse. Right and left click-operation buttons 14, 14 are formed from light-transmitting material. Reference numeral 6 designates a-cord which connects electronics within casing with computer system. The cord may be stored within the main body casing 2.

Material of the main body casing 2 used for the mouse of this invention is not specified, but in general, the main body casing 2 is formed from synthetic resin, for example ABS resin or the like. The ball 5 is provided as a movement detection device below the upper lid 26. An inner plate 28 having a pressure means 27 for fixing the ball 5 is formed from light-transmitting material. A diffusion plate 29 is formed between the inner plate 28 and the upper lid 26. The diffusion plate 29 is configured so that the light radiated from inside of the mouse may be diffused. Light emitting elements 30 such as LED are arranged below the click-operation buttons 14, 14 of the bottom plate 4. Even only one small light-emitting element provided on the bottom plate 4 can diffuse light over entire surfaces of the click-operation buttons 14 and the entire surfaces of the click-operation buttons 14 can be illuminated with appropriate luminosity.

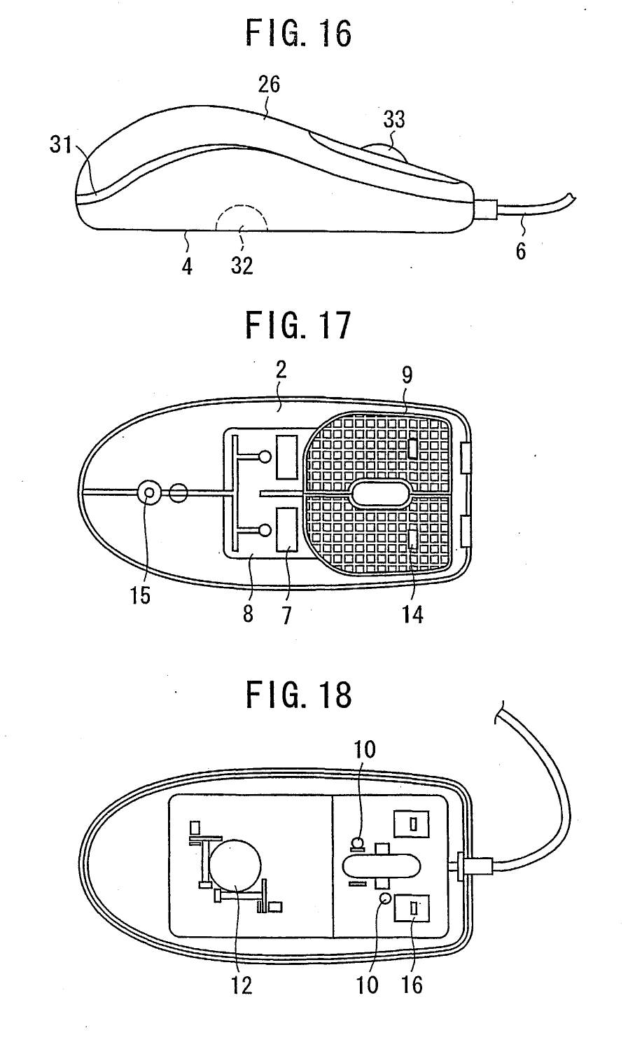

In the seventh embodiment of this invention shown in FIG. 16, a stripe 31 with metallic luster is arranged in the boundary portion between the upper lid 26 and the bottom plate 4. This stripe is for example formed from a chromium-plated element. Reference numeral 32 designates an optical movement detection device for detecting amount of the movement by emitting infrared rays. Reference numeral 33 designates a rotating wheel for scrolling the screen image of the display which is connected via the cord 5 with the mouse, when the mouse is operated. Reference numeral 34 designates a pressure means placed under the operation buttons 14. Reference number 35 designates a screw hole for fixing the upper lid 26 to the bottom plate 4.

In the case of the above-mentioned mouse of this invention, the light-emitting elements 30 are activated so that the entire main body casing 2 is faintly illuminated when the main body casing 2 is touched, or when the main body casing 2 is held and the main body casing 2 is operated, with the upper lid 26 coupled to the bottom plate 4.

Additionally, when the main body casing 2 is held to click-operate and any one of operation buttons 14 is depressed, a open-close switch 36 is turned on by the pressure means 34 protruding on the inner plate 28 of the click operation button 14, a electric circuit is closed and the light emitting element 30 is activated. In the case that the mouse is formed as a optical movement detection device for detecting amount of the casing movement of the mouse, the light is always emitted during the mouse operation, and otherwise less brightly emitted. This light emitting element 30 emits colored light, and the click operation buttons 14 also gives colored light outward. Accordingly, it can be visually recognized that the mouse is operated.

Industrial Applicability of the Invention

As above-mentioned, the mouse of this invention has improved portability without necessity of bundling the cord together when carrying it. This is for the reason that the cord inclusive of the connecter thereof can be stored within the mouse body with an ensured practical length, because the cord is thinned down. Additionally, when casing is handled, or right or left click operation button is click-operated, the light-emitting element is activated so that the entire casing is brightly illuminated or the click buttons is illuminated with appropriate luminosity. Therefore, the operation can be recognized. The decorative effect of the mouse meets needs of young users recently increasing.

What is claimed is:

1. A mouse provided therein with a cord storage compartment into which the cord can be retracted and stored, said mouse adapted to be electrically connected to an input board of a computer system comprising an upper lid having thereon right and left manual operation buttons, a bottom frame and said storage compartment within which the cord extending between the mouse and said input board is directly stored in folded up state or taken up around a reel mechanism, said mouse being characterized by that:
a main body of the mouse contains therein a detector mechanism adapted to detect an amount by which the main body of the mouse is moved, a wiring board having an electronic control circuit thereon and said storage having a space sufficient large to store the cord inclusive of a terminal section as well as a connector on a distal end of the cord, wherein said storage compartment is provided on its opening side with an open- and closable lid.

2. The mouse provided therein with a cord storage compartment into which the cord can be retracted and stored according to claim 1, wherein said storage compartment is provided on a lateral side of the main body of the mouse and said open- and closable lid is formed by a side wall or a bottom wall of said main body of the mouse.

3. The mouse provided therein with a cord storage compartment into which the cord can be retracted and stored according to claim 1 or 2, wherein the cord to be stored together with said terminal section and said connector into said storage compartment is automatically or manually taken up around said reel mechanism and thereby stored within said storage compartment and wherein, after said terminal section and connector on the distal end of the cord have been taken out from said storage compartment and said open- and closable lid has been closed, a desired length of the cord can be adjustably reeled out from said storage compartment.

4. The mouse provided therein with a cord storage compartment into which the cord can be retracted and stored according to any one of claims 1-3, wherein said terminal section and connector are biased to bounce out from said storage compartment automatically as said open- and closable lid is opened.

5. A mouse defined by a bottom frame and an upper lid provided with right and left operating buttons and containing therein a wiring board supporting an electronic control circuit and a detector mechanism adapted to detect an amount by which the mouse is moved, said mouse being characterized by that:
said mouse further includes light emitting elements adapted to be turned on as said mouse is moved and/or click buttons are depressed and thereby to illuminate said upper lid entirely or partially or to illuminate only said click buttons with appropriate luminosity.

6. A mouse defined by a bottom frame and an upper lid provided with right and left operating buttons and containing therein a wiring board supporting an electronic control circuit and a detector mechanism adapted to detect an amount by which the mouse is moved, said mouse being characterized by that:
portions of said upper lid defining said click buttons are formed by suitable light-transmitting members and light emitting elements underlie these click buttons, said light emitting elements being adapted to be turned on as said mouse is moved and/or click buttons are depressed and thereby to illuminate said click buttons so that how the mouse is functioning can be visually recognized by the user.

7. The mouse according to claim 6, wherein said light transmitting members forming said click buttons include diffusing plates adapted to diffuse the incident light coming from the underlying light emitting elements.

8. A mouse defined by a bottom frame and an upper lid provided with right and left operating buttons and containing therein a wiring board supporting an electronic control circuit and a detector mechanism adapted to detect an amount by which the mouse is moved, said mouse being characterized by that:
a part of said upper lid or a boundary between said upper lid and said bottom frame is provided with rectilinear or streamlined stripes having metallic luster.

9. A mouse provided therein with a cord storage compartment into which the cord can be retracted and stored, said mouse adapted to be electrically connected to an input board of a computer system comprising an upper lid having thereon right and left manual operation buttons, a bottom frame and said storage compartment within which the cord extending between the mouse and said input board is directly stored in folded up state or taken up around a reel mechanism, said mouse being characterized by that:
a main body of the mouse contains therein a detector mechanism adapted to detect an amount by which the main body of the mouse is moved, a wiring board having an electronic control circuit thereon and said storage having a space sufficient large to store the cord inclusive of a terminal section as well as a connector on a distal end of the cord, wherein said storage compartment is provided on its opening side with an open- and closable lid; and
said mouse further includes light emitting elements adapted to be turned on as said mouse is moved and/or click buttons are depressed and thereby to illuminate said upper lid entirely or partially or to illuminate only said click buttons with appropriate luminosity.

11. A mouse provided therein with a cord storage compartment into which the cord can be retracted and stored, said mouse adapted to be electrically connected to an input board of a computer system comprising an upper lid having thereon right and left manual operation buttons, a bottom frame and said storage compartment within which the cord extending between the mouse and said input board is directly stored in folded up state or taken up around a reel mechanism, said mouse being characterized by that:
a main body of the mouse contains therein a detector mechanism adapted to detect an amount by which the main body of the mouse is moved, a wiring board having an electronic control circuit thereon and said storage having a space sufficient large to store the cord inclusive of a terminal section as well as a connector on a distal end of the cord, wherein said storage compartment is provided on its opening side with an open- and closable lid; and
portions of said upper lid defining said click buttons are formed by suitable light-transmitting members and light emitting elements underlie these click buttons, said light emitting elements being adapted to be turned on as said mouse is moved and/or click buttons are depressed and thereby to illuminate said click buttons so that how the mouse is functioning can be visually recognized by the user.

12. A mouse provided therein with a cord storage compartment into which the cord can be retracted and stored, said mouse adapted to be electrically connected to an input board of a computer system comprising an upper lid having thereon right and left manual operation buttons, a bottom frame and said storage compartment within which the cord extending between the mouse and said input board is directly stored in folded up state or taken up around a reel mechanism, said mouse being characterized by that:
a main body of the mouse contains therein a detector mechanism adapted to detect an amount by which the main body of the mouse is moved, a wiring board having an electronic control circuit thereon and said storage having a space sufficient large to store the cord inclusive of a terminal section as well as a connector on a distal end of the cord, wherein said storage compartment is provided on its opening side with an open- and closable lid; and
a part of said upper lid or a boundary between said upper lid and said bottom frame is provided with rectilinear or streamlined stripes having metallic luster.
